(19) United States
(12) Patent Application Publication
(10) Pub. No.: US 2026/0343368 A1
(43) Pub. Date: Oct. 29, 2026

(54) UE MOBILITY ENHANCEMENT IN MOBILE IAB

(71) Applicant: Apple Inc., Cupertino, CA (US)

(72) Inventors: Peng Cheng, Beijing (CN); Yuqin Chen, Beijing (CN); Fangli Xu, Beijing (CN); Ralf Rossbach, Munich (DE); Haijing Hu, Los Gatos, CA (US)

(73) Assignee: Apple Inc., Cupertino, CA (US)

(21) Appl. No.: 19/102,358

(22) PCT Filed: Aug. 8, 2022
(86) PCT No.: PCT/CN2022/110905

§ 371 Date: Feb. 7, 2025

(51) Int. Cl. H04W 36/32; H04W 36/08; H04W 64/00; H04W 84/04

(52) U.S. Cl. CPC H04W 36/324; H04W 36/083; H04W 36/322; H04W 64/006; H04W 84/047

(57) ABSTRACT

Provided is a method for a user equipment (UE). The UE detects a mobile indication provided by a mobile base station. The mobile indication indicates a mobility property of the mobile base station. The UE determines whether it is moving together with the mobile base station. In response to determining that the UE is moving together with the mobile base station, the UE applies a behavior based on the mobile indication.

### TECHNICAL FIELD

This application relates generally to wireless communication systems, and more specifically to UE mobility enhancement in mobile integrated access and backhaul (IAB).

### BACKGROUND

Wireless mobile communication technology uses various standards and protocols to transmit data between a base station and a wireless mobile device. Wireless communication system standards and protocols can include, but not limited to, the 3rd Generation Partnership Project (3GPP) long term evolution (LTE); fifth-generation (5G) 3GPP new radio (NR) standard; and technologies beyond 5G. In fifth-generation (5G) wireless radio access networks (RANs), the base station may include an RAN Node such as a 5G Node, new radio (NR) node or g Node B (gNB), which communicate with a wireless communication device, also known as user equipment (UE).

The IAB was introduced in NR release 16 and the work has been going on further. The IAB can provide flexible and scalable multi-hop backhauling, using the same or different frequency bands for access and backhaul. The IAB donor is a logical node that provides the NR-based wireless backhaul and the IAB node is wireless backhauled to the IAB donor. Recently, many efforts and attentions have been drawn to the mobile IAB, in which scenario the enhancement to the UE mobility also needs to be discussed further.

### SUMMARY

According to an aspect of the present disclosure, a method for a user equipment (UE) is provided that comprises detecting a mobile indication provided by a mobile base station, wherein the mobile indication indicates a mobility property of the mobile base station; determining whether the UE is moving together with the mobile base station; and in response to determining that the UE is moving together with the mobile base station, applying a behavior based on the mobile indication. According to an aspect of the present disclosure, an apparatus for a UE is provided that includes one or more processors configured to perform steps of the method according to the present disclosure.

According to an aspect of the present disclosure, a computer readable medium is provided that has computer programs stored thereon, which when executed by one or more processors, cause an apparatus to perform steps of the method according to the present disclosure.

According to an aspect of the present disclosure, a method for a mobile base station is provided that comprises configuring a mobile indication for indicating a mobility property of the mobile base station; and providing the mobile indication to a UE.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates a flowchart for an exemplary method for a UE in accordance with some embodiments.

FIG. 3 illustrates an exemplary diagram of mobile base stations containing different mobile indications.

FIG. 4 illustrates an exemplary diagram for a UE behavior based on the mobile indication.

FIG. 5 illustrates another exemplary diagram for a UE behavior based on the mobile indication.

FIG. 6 illustrates a flowchart for an exemplary method for a mobile base station in accordance with some embodiments.

FIG. 7 illustrates an exemplary block diagram of an apparatus for a UE in accordance with some embodiments.

FIG. 8 illustrates an exemplary block diagram of an apparatus for a mobile base station in accordance with some embodiments.

FIG. 9 illustrates example components of a device in accordance with some embodiments.

FIG. 10 illustrates example interfaces of baseband circuitry in accordance with some embodiments.

FIG. 11 illustrates components in accordance with some embodiments.

FIG. 12 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In the technologies related to the mobile integrated access and backhaul (IAB) node, new requirements for the mobility enhancement when the UE moves together with the serving mobile IAB node are still being discussed.

In a conventional solution, such as high-speed dedicated network (HSDN), although the serving base station may indicate its mobility to the UE, inaccurate behaviors in terms of the cell reselection, the UE access and the UE handover between the stationary network and the mobile IAB node and/or between the mobile IAB nodes may occur.

In addition, since the mobile IAB node may be deployed within various application scenarios, such as a train, a bus or a drone, a specific configuration of the mobile IAB node applying to those circumstances also needs to be considered, so that the UE may determine how to behave under those circumstances.

Aiming to this, it is provided by the present disclosure the UE mobility enhancement in the mobile IAB. Various aspects of the present disclosure will be described below in conjunction with the accompanying drawings.

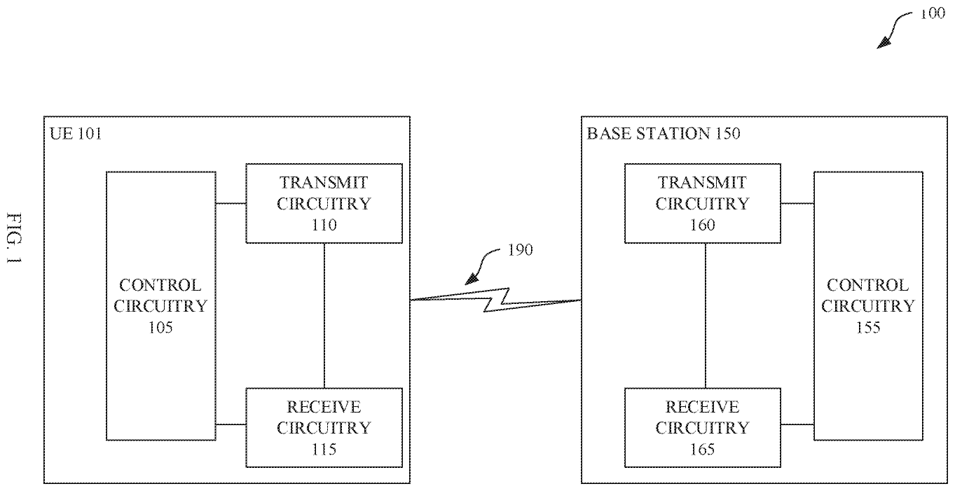

FIG. 1 is a block diagram of a system including a base station and a UE in accordance with some embodiments. FIG. 1 illustrates a wireless network 100, in accordance with some embodiments. The wireless network 100 includes a UE 101 and a base station 150 connected via an air interface 190. In some embodiments, the base station 150 may be a mobile base station, such a mobile IAB node.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with Machine Type Communication (MTC). In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuity 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g., messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person-to-person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is included of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is included of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

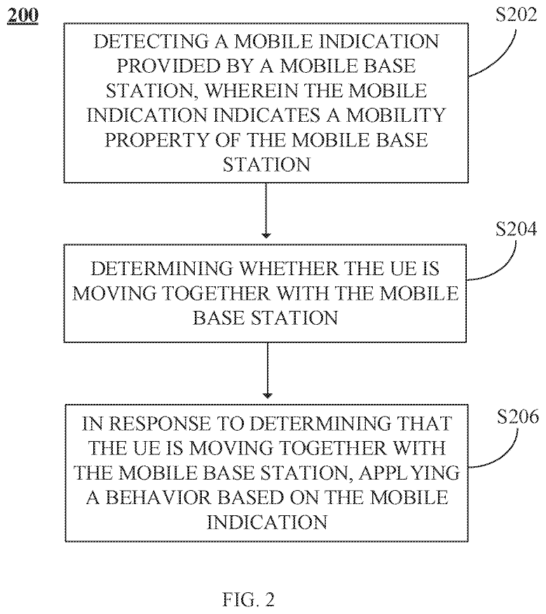

FIG. 2 illustrates a flowchart for an exemplary method for a UE in accordance with some embodiments. In some embodiment, the method 200 illustrated in FIG. 2 may be implemented by the UE 101 described in FIG. 1.

In some embodiments, as shown in FIG. 2, the method 200 for a UE includes the following steps: S202, detecting a mobile indication provided by a mobile base station, wherein the mobile indication indicates a mobility property of the mobile base station; S204, determining whether the UE is moving together with the mobile base station; and S206, in response to determining that the UE is moving together with the mobile base station, applying a behavior based on the mobile indication.

According to the method of some embodiments of the present disclosure, the UE may perform an accurate behavior based on the mobile indication indicating the mobility property of the mobile base station, which enables the UE mobility enhancement and avoids potential reference and control signal collisions. Based on the mobile indication provided by the mobile base station, it is possible for the UE to determine how to behave in a corresponding manner, so that the enhancement to the cell reselection, the UE access and the UE handover between the stationary network and the mobile base station and/or between the mobile base stations may be achieved.

In the following, each step of the method 200 will be described in detail.

At step S202, the UE detects the mobile indication provided by the mobile base station. The mobile indication indicates the mobility property of the mobile base station.

In some embodiments, the mobile base station may comprise an integrated access and backhaul (IAB) node.

In some embodiments, the mobile indication may be included in a system information block type 1 (SIB1) of the mobile base station as one or more bits to indicate the moving property of the mobile base station including at least one of a moving type, a moving speed and a moving trajectory.

In some embodiments, the mobile indication may include a bit to indicate the moving type of the mobile base station. In an example, the mobile base station deployed on a train may have one bit indicating that the moving type is a train (a similar case as in the HSDN). In another example, the mobile base station deployed on a bus may have one bit indicating that the moving type is a bus. Similarly, the moving type may be a car, a drone, or a ship etc.

In some embodiments, the mobile indication may include a further bit to indicate the moving speed of the mobile base station. This bit may indicate a moving speed range of the mobile base station. The moving speed range may be fixed in the specification, or may be configured in the SIB or the non-access stratum (NAS) signaling.

In some embodiments, the mobile indication may include another further bit to indicate the moving trajectory of the mobile base station. For example, this bit may indicate the moving trajectory of the mobile base station is a straight line, a circle or an irregular track etc. In an example, the network may maintain a public database where different mobile base station can register their planned journey.

In some embodiments, the mobile indication may be configured with more than one bit to indicate the moving property of the mobile base station, which may include any combination of a moving type, a moving speed and/or a moving trajectory.

According to the method of some embodiments of the present disclosure, by detecting the mobile indication indicating the moving property of the mobile base station including at least one of the moving type, the moving speed and the moving trajectory, it is possible to facilitate the UE to determine the mobile base station with which it is moving together. In this way, the UE can perform an accurate behavior, such as the cell reselection, the UE access and the UE handover to achieve the UE mobility enhancement.

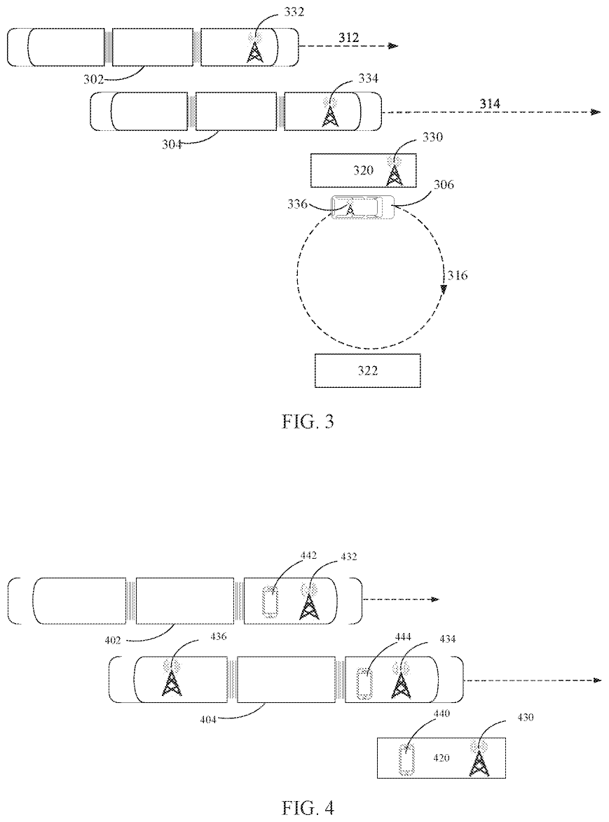

FIG. 3 illustrates an exemplary diagram of mobile base stations containing different mobile indications.

As shown in FIG. 3, a high-speed train 304 and a low-speed train 302 are passing through a train station 320. In the meantime, a shuttle bus 306 running between the train station 320 and an airport 322 is also passing through the train station 320. Each of the high-speed train 304, the low-speed train 302 and the shuttle bus 306 may have a respective mobile base station 334, 332 and 336 arranged thereon. A stationary base station 330 may be arranged in the train station 320.

In some embodiments, for the mobile base station 334 on the high-speed train 304, the mobile indication thereof may indicate at least one of the following mobility properties: 1) the moving type is a train; 2) the moving speed is a certain high speed range; and 3) the moving trajectory is a straight line 314.

In some embodiments, for the mobile base station 332 on the low-speed train 302, the mobile indication thereof may indicate at least one of the following mobility properties: 1) the moving type is a train; 2) the moving speed is a certain medium speed range; and 3) the moving trajectory is a straight line 312.

In some embodiments, for the mobile base station 336 on the shuttle bus 306, the mobile indication thereof may indicate at least one of the following mobility properties: 1) the moving type is a bus; 2) the moving speed is a certain low speed range; and 3) the moving trajectory is a circle 316.

The moving speed may be configured in a speed range manner. In some embodiments, a speed range over 200 km/h (for example, the high-speed train 304) may be considered as a high speed range. In some embodiments, a speed range between 100 km/h and 200 km/h (for example, the low-speed train 302) may be considered as a medium speed range. In some embodiments, a speed range below 100 km/h (for example, the shuttle bus 306) may be considered as a low speed range.

Back to FIG. 2, at step S204, the UE determines whether it is moving together with the mobile base station.

In some embodiments, the step that the UE determines whether it is moving together with the mobile base station may be based on a UE implementation, a condition provided together with the mobile indication, or a positioning of the UE. In this way, the UE can identify the mobile base station with which it is moving together through various methods, which improves the accuracy of the identification.

In some embodiments, the UE may determine that it is moving together with the mobile base station based on the UE implementation.

In some embodiments, the UE may determine that it is moving together with the mobile base station based on the condition provided together with the mobile indication. The condition provided together with the mobile indication may comprise a speed threshold, a doppler spread threshold, a measurement sensitivity threshold, or a number of across-cell per unit time threshold.

In some embodiments, the UE may determine that it is moving together with the mobile base station by determining that the moving speed of the UE satisfies the speed threshold.

In some embodiments, the UE may determine that it is moving together with the mobile base station by determining that the doppler spread of the UE satisfies the doppler spread threshold.

In some embodiments, the UE may the determine that it is moving together with the mobile base station by determining that the measurement sensitivity of the UE satisfies the measurement sensitivity threshold.

In some embodiments, the UE may the determine that it is moving together with the mobile base station by determining that the number of across-cell per unit time of the UE satisfies the number of across-cell per unit time threshold.

According to the method of some embodiments of the present disclosure, with the help of the various conditions provided together with the mobile indication, the UE may improve the accuracy of identifying the mobile base station with which it is moving together.

In some embodiments, the UE may determine that it is moving together with the mobile base station based on the positioning of the UE. In some embodiments, the positioning of the UE may be obtained from a Global Navigation Satellite System (GNSS) or a Global Positioning System (GPS). In an example, the moving speed and the moving trajectory of the UE may be determined after the positioning of the UE is obtained.

At step S206, in response to determining that the UE is moving together with the mobile base station, the UE applies a behavior based on the mobile indication.

In some embodiments, the step that the UE applies a behavior based on the mobile indication may comprise: the UE performs a cell reselection by regarding a cell or a frequency with the same mobile indication as a highest priority.

In some embodiments, based on the mobile indication, the UE may consider a cell or a frequency of a mobile station with which the UE is moving together as a highest priority. On the contrary, a cell or a frequency of a mobile station with which the UE is not moving together may be considered as a lower priority.

According to the method of some embodiments of the present disclosure, by applying a priority rule, the chance for the UE to select a cell or a frequency of a mobile station with which the UE is moving together is increased.

In some embodiments, the step that the UE applies a behavior based on the mobile indication may comprise: the UE performs a cell reselection by applying a configured scaling factor or offset to an idle measurement for a cell or frequency with the same mobile indication, wherein the configured scaling factor or offset is provided in the SIB1 of the mobile base station.

In some embodiments, the idle measurement for a cell or frequency with the same mobile indication may be at least one of: reference signal received power (RSRP), reference signal received quality (RSRQ), time interval TreselectionRAT and Qhyst (quality hysterisis).

According to the method of some embodiments of the present disclosure, since the configured scaling factor or offset can improve the measurement quality, the chance for the UE to select a cell or a frequency of a mobile station with which the UE is moving together is increased.

In some embodiments, the step that the UE applies a behavior based on the mobile indication comprises: the UE performs a cell reselection by applying a configured scaling factor or offset to a cell reselection threshold for a cell or frequency with the same mobile indication, wherein the configured scaling factor or offset is provided in the SIB1 of the mobile base station.

In some embodiments, the cell reselection threshold may be at least one of: SnonIntraSearchP, SnonIntraSearchQ, ThreshX, HighQ, ThreshX, LowQ, ThreshX, HighP, ThreshServing and LowP.

According to the method of some embodiments of the present disclosure, the chance for the UE to select a cell or a frequency of a mobile station with which the UE is moving together is increased, by reducing the cell reselection threshold of this mobile station.

FIG. 4 illustrates an exemplary diagram for a UE behavior based on the mobile indication.

As shown in FIG. 4, a high-speed train 404 and a low-speed train 402 are passing through a train station 420. Each of the high-speed train 404 and the low-speed train 402 may have a respective mobile base station 434, 432 arranged thereon. The UE 444 and 442 are moving as the high-speed train 404 and the low-speed train 402 are moving, respectively. A stationary base station 430 may be arranged in the train station 420. A UE 440 is stationary or moving with the user in the train station 420.

In some embodiments, in response to determining that the UE 444 is moving together with the mobile base station 434, the UE 444 may select a cell or a frequency of the mobile station 434 by regarding the associated cell or frequency as a highest priority, or apply a configured scaling factor or offset, in order to improve the idle measurement for the associated cell or to reduce the cell reselection threshold for the associated cell. In this way, the chance for the UE 444 to select the mobile base station 432 or the stationary base station 430 is decreased.

In some embodiments, more than one mobile base station may be arranged on a train. As shown in FIG. 4, the high-speed train 404 may be deployed with, e.g., two mobile base stations 434 and 436. These two mobile base stations 434 and 436 may be configured with the same mobile indication. During the cell reselection, the UE 444 may consider the mobile base stations 434 and 436 as a highest priority.

In some embodiments, the step that the UE applies a behavior based on the mobile indication may comprise: the UE performs a cell reselection by regarding a cell or a frequency with a different mobile indication or without the mobile indication as a lowest priority.

Continuing to refer to FIG. 4, in some embodiments, the UE 444 moving together with the mobile base stations 434 and 436 may consider the mobile base station 432 as a lowest priority, since the mobile base station 432 is arranged on the low-speed train 402 and thus configures a different mobile indication. In some embodiments, the UE 444 may consider the stationary base station 430 as a lowest priority, since the stationary base station 430 is not configured with the mobile indication. Similarly, in some embodiments, the UE 440 not moving together with the mobile base stations 434 and 436 may consider the mobile base stations 434 and 436 as a lowest priority.

In some embodiments, the cell with the same mobile indication may be provided in a cell list for an intra-frequency cell reselection in a system information block type 3 (SIB3) of the mobile base station, and the frequency with the same mobile indication may be provided in a frequency list for an inter-frequency cell reselection in a system information block type 4 (SIB4) of the mobile base station.

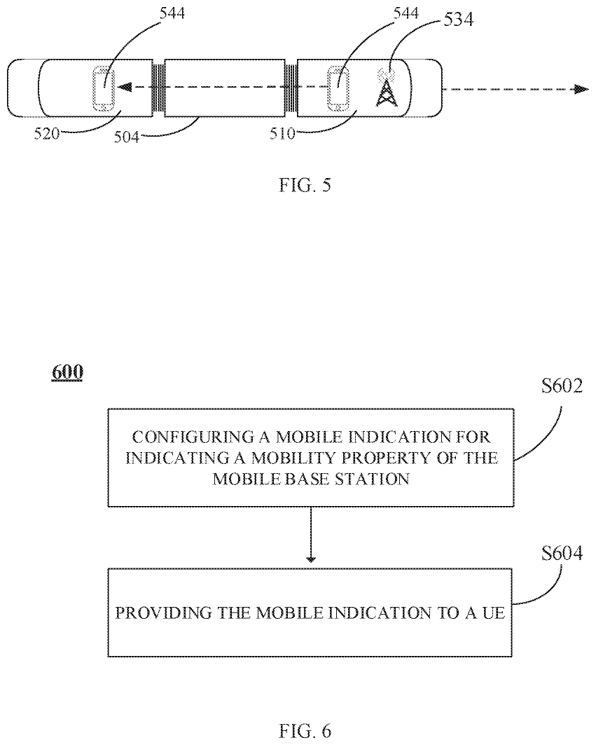

FIG. 5 illustrates another exemplary diagram for a UE behavior based on the mobile indication. As shown in FIG. 5, a UE 544 may move from a location on the train 504 to another location on the train 504 (for example, from a carriage 510 to another carriage 520). In some embodiments, the SIB3 of the mobile base station 534 may provide a list of candidate cells for the UE 544 to perform an intra-frequency cell reselection, where the candidate cells are associated with the mobile base station 534 arranged on the train 504. In some embodiments, the SIB4 of the mobile base station 534 may provide a list of candidate cells for the UE 544 to perform an inter-frequency cell reselection, where the candidate cells are associated with the mobile base station 534 arranged on the train 504. Therefore, the UE 544 may be less likely to select cells or frequencies not included in these lists.

According to the method of some embodiments of the present disclosure, with the cell list for the intra-frequency cell reselection and the frequency list for the inter-frequency cell reselection, the UE may preferably select a cell or frequency from the two lists. Therefore, the chance for the UE to select a cell or a frequency of a mobile station with which the UE is moving together is increased.

In some embodiments, in response to determining that the UE is not moving together with the mobile base station, the UE may perform no access to a cell of the mobile base station, wherein a 1-bit indication is provided in the SIB1 of the mobile base station to indicate that the cell is only accessible for the UE moving together with the mobile base station.

Referring back to FIG. 4, the UE 420 may detect the existence of the stationary base station 430, the mobile base station 434 and the mobile base station 432 at the same time. Since a 1-bit indication is provided in the SIB1 of each of the mobile base stations 434 and 432, which indicates that the cell is only accessible for the UE moving together with the mobile base station, the UE 420 may be barred from accessing to the mobile base stations 434 and 432, because it is not moving together with either of them.

According to the method of some embodiments of the present disclosure, since the UE not moving together with the mobile base station will not access to the mobile base station, the overhead of the mobile base station can be reduced and more resources can be allocated to the UE moving together with the mobile base station.

In some embodiments, the UE that is not moving together with the mobile base station may apply a reserved access identity (AI).

In some embodiments, the reserved access identity may be applied to the UE that is not moving together with the mobile base station. In this way, this UE may have less probability to access the mobile base station. Therefore, the overhead of the mobile base station can be reduced and more resources can be allocated to the UE moving together with the mobile base station.

In some embodiments, the step that the UE applies a behavior based on the mobile indication may comprise: the UE performs a measurement for handover only for a cell or frequency with the same mobile indication.

In some embodiments, the step that the UE applies a behavior based on the mobile indication may comprise: the UE performs a measurement for handover based on a dedicated trigger event condition for a cell or frequency with a different mobile indication.

In some embodiments, the dedicated trigger event condition may be configured for a cell or frequency with a different mobile indication. Thus, the UE moving together with the mobile base station may have less chance to report measurement of a cell or frequency with a different mobile indication to this mobile base station. In this way, the triggered measurement report for a frequency/cell with different mobile indication can be reduced and the overhead of the mobile base station can be mitigated.

In some embodiments, the dedicated trigger event condition may comprise at least one of a measurement trigger threshold for events A1 to A6, a hysteresis for events A1 to A6 and a timer to trigger for events A1 to A6.

In some embodiments, in response to the measurement trigger for events A1 to A6 satisfies a measurement trigger threshold, the measurement report may be triggered.

In some embodiments, in response to the hysteresis for events A1 to A6 satisfies a hysteresis threshold, the measurement report may be triggered.

In some embodiments, in response to the timer to trigger for events A1 to A6 satisfies a timing threshold, the measurement report may be triggered.

In some embodiments, the step that the UE applies a behavior based on the mobile indication may comprise: the UE performs a measurement for handover based on a dedicated measurement object or quantity, or a list of neighbor cells.

In some embodiments, the step that the UE applies a behavior based on the mobile indication may comprise: the UE performs a conditional handover (CHO) based on a CHO condition in which the mobile indication of a candidate target cell, a dedicated CHO condition and a dedicated time to trigger are provided.

In some embodiments, the candidate target cell with the same mobile indication may be prioritized for CHO execution.

In some embodiments, the candidate target cell with a different mobile indication is less prioritized for CHO execution.

In some embodiments, candidate target cells with different mobile indications may be configured with a stricter condition, while candidate target cells with the same mobile indication may be configured with an easier condition. In this way, the chance for the UE to select a cell or a frequency with a different mobile indication is decreased. In other words, the UE may have less chance to pick a target cell with a different mobile indication.

In some embodiments, an apparatus for the UE may include one or more processors configured to perform any of steps of the above methods according to the present disclosure.

In some embodiments, a computer readable medium may have computer programs stored thereon which, when executed by one or more processors, cause an apparatus to perform any of steps of the above methods according to the present disclosure.

FIG. 6 illustrates a flowchart for an exemplary method for a mobile base station in accordance with some embodiments. The method 600 illustrated in FIG. 6 may be implemented by the base station 150 described in FIG. 1. For example, the base station 150 may be a mobile base station.

In some embodiments, the method 600 for a mobile base station may include the following steps: S602, configuring a mobile indication for indicating a mobility property of the mobile base station; and S604, providing the mobile indication to a UE.

In the following, each step of the method 600 will be described. Note that those elements, expressions, features etc. that have already been described with reference to FIG. 2 and the corresponding description (about the UE) are omitted for clarity.

At step S602, the mobile base station configures the mobile indication for indicating the mobility property of the mobile base station.

At step S604, the mobile base station provides the mobile indication to the UE.

According to the method of some embodiments of the present disclosure, the UE may perform an accurate behavior based on the mobile indication indicating the mobility property of the mobile base station, which enables a UE mobility enhancement and avoids potential reference and control signal collisions.

In some embodiments, the mobile indication may be included in the SIB1 of the mobile base station as one or more bits to indicate the moving property of the mobile base station including at least one of a moving type, a moving speed and a moving trajectory.

According to the method of some embodiments of the present disclosure, with the help of the mobile indication indicating the moving property of the mobile base station including at least one of the moving type, the moving speed and the moving trajectory, it is possible to facilitate the UE to determine the mobile base station with which it is moving together. In this way, the UE can perform an accurate behavior, such as the cell reselection, the UE access and the UE handover to achieve the UE mobility enhancement.

In some embodiments, the mobile base station may comprise the IAB node.

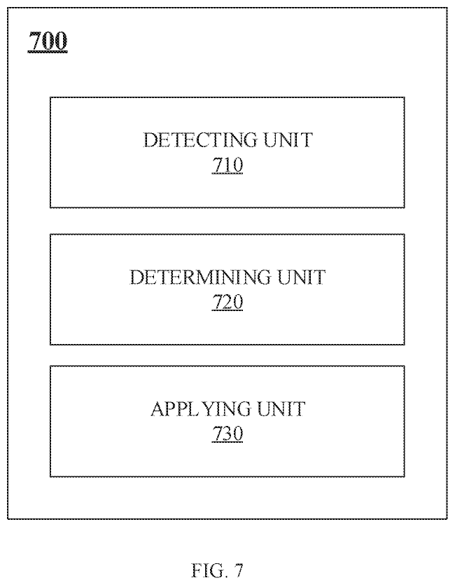

FIG. 7 illustrates an exemplary block diagram of an apparatus for a UE in accordance with some embodiments. The apparatus 700 illustrated in FIG. 7 may be used to implement the method 200 as illustrated in combination with FIG. 2.

As illustrated in FIG. 7, the apparatus 700 includes a detecting unit 710, a determining unit 720 and an applying unit 730.

The detecting unit 710 is configured to detect a mobile indication provided by a mobile base station, wherein the mobile indication indicates a mobility property of the mobile base station.

The determining unit 720 is configured to determine whether the UE is moving together with the mobile base station.

The applying unit 730 is configured to apply a behavior based on the mobile indication in response to determining that the UE is moving together with the mobile base station.

According to the apparatus of some embodiments of the present disclosure, the UE may perform an accurate behavior based on the mobile indication indicating the mobility property of the mobile base station, which enables a UE mobility enhancement and avoids potential reference and control signal collisions.

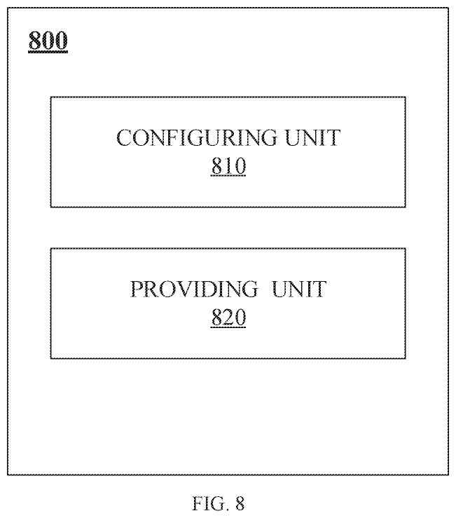

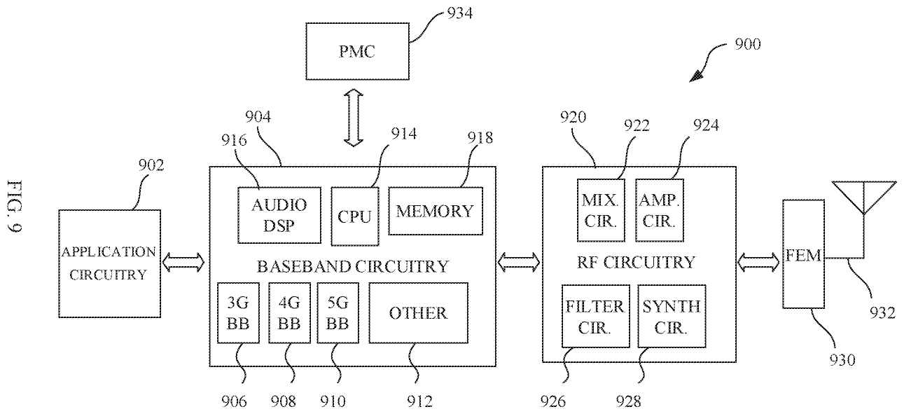

FIG. 8 illustrates an exemplary block diagram of an apparatus for a mobile base station in accordance with some embodiments. The apparatus 800 illustrated in FIG. 8 may be used to implement the method 600 as illustrated in combination with FIG. 6.

As illustrated in FIG. 8, the apparatus 800 includes a configuring unit 810 and a providing unit 820.

The configuring unit 810 is configured to configure a mobile indication for indicating a mobility property of the mobile base station.

The providing unit 820 is configured to provide the mobile indication to a UE.

According to the apparatus of some embodiments of the present disclosure, the UE may perform an accurate behavior based on the mobile indication indicating the mobility property of the mobile base station, which enables a UE mobility enhancement and avoids potential reference and control signal collisions.

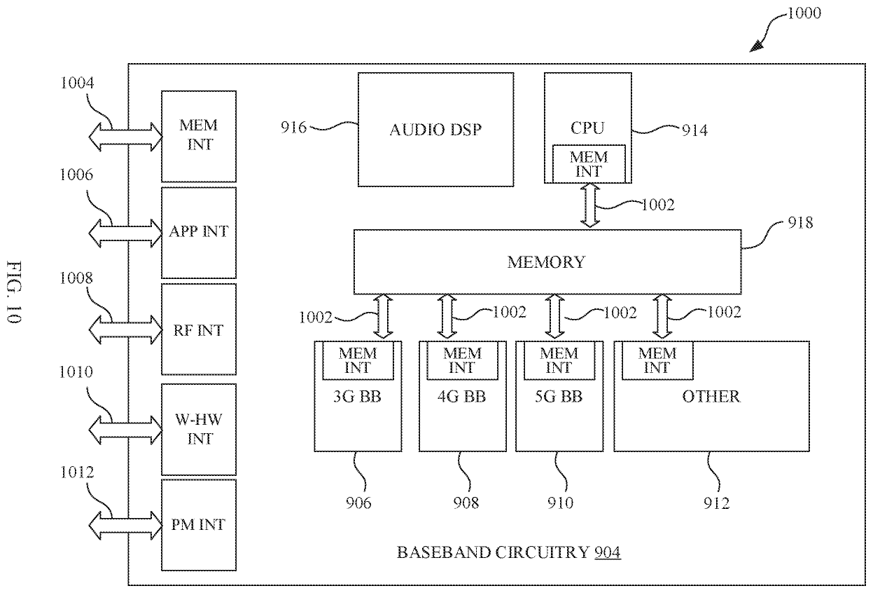

FIG. 9 illustrates example components of a device 900 in accordance with some embodiments. In some embodiments, the device 900 may include application circuitry 902, baseband circuitry 904, Radio Frequency (RF) circuitry (shown as RF circuitry 920), front-end module (FEM) circuitry (shown as FEM circuitry 930), one or more antennas 932, and power management circuitry (PMC) (shown as PMC 934) coupled together at least as shown. The components of the illustrated device 900 may be included in a UE or a RAN node. In some embodiments, the device 900 may include fewer elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 920 and to generate baseband signals for a transmit signal path of the RF circuitry 920. The baseband circuitry 904 may interface with the application circuitry 902 for generation and processing of the baseband signals and for controlling operations of the RF circuitry 920. For example, in some embodiments, the baseband circuitry 904 may include a third generation (3G) baseband processor (3G baseband processor 906), a fourth generation (4G) baseband processor (4G baseband processor 908), a fifth generation (5G) baseband processor (5G baseband processor 910), or other baseband processor(s) 912 for other existing generations, generations in development or to be developed in the future (e.g., second generation (2G), sixth generation (6G), etc.). The baseband circuitry 904 (e.g., one or more of baseband processors) may handle various radio control functions that enable communication with one or more radio networks via the RF circuitry 920. In other embodiments, some or all of the functionality of the illustrated baseband processors may be included in modules stored in the memory 918 and executed via a Central Processing Unit (CPU 914). The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include a digital signal processor (DSP), such as one or more audio DSP(s) 916. The one or more audio DSP(s) 916 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 904 is configured to support radio communications of more than one wireless protocol may be referred to as multi-mode baseband circuitry.

The RF circuitry 920 may enable communication with wireless networks using modulated electromagnetic radiation through a non-solid medium. In various embodiments, the RF circuitry 920 may include switches, filters, amplifiers, etc. to facilitate the communication with the wireless network. The RF circuitry 920 may include a receive signal path which may include circuitry to down-convert RF signals received from the FEM circuitry 930 and provide baseband signals to the baseband circuitry 904. The RF circuitry 920 may also include a transmit signal path which may include circuitry to up-convert baseband signals provided by the baseband circuitry 904 and provide RF output signals to the FEM circuitry 930 for transmission.

In some embodiments, the receive signal path of the RF circuitry 920 may include mixer circuitry 922, amplifier circuitry 924 and filter circuitry 926. In some embodiments, the transmit signal path of the RF circuitry 920 may include filter circuitry 926 and mixer circuitry 922. The RF circuitry 920 may also include synthesizer circuitry 928 for synthesizing a frequency for use by the mixer circuitry 922 of the receive signal path and the transmit signal path. In some embodiments, the mixer circuitry 922 of the receive signal path may be configured to down-convert RF signals received from the FEM circuitry 930 based on the synthesized frequency provided by synthesizer circuitry 928. The amplifier circuitry 924 may be configured to amplify the down-converted signals and the filter circuitry 926 may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, the mixer circuitry 922 of the receive signal path may include passive mixers, although the scope of the embodiments is not limited in this respect.

In some embodiments, the mixer circuitry 922 of the transmit signal path may be configured to up-convert input baseband signals based on the synthesized frequency provided by the synthesizer circuitry 928 to generate RF output signals for the FEM circuitry 930. The baseband signals may be provided by the baseband circuitry 904 and may be filtered by the filter circuitry 926.

In some embodiments, the mixer circuitry 922 of the receive signal path and the mixer circuitry 922 of the transmit signal path may include two or more mixers and may be arranged for quadrature downconversion and upconversion, respectively. In some embodiments, the mixer circuitry 922 of the receive signal path and the mixer circuitry 922 of the transmit signal path may include two or more mixers and may be arranged for image rejection (e.g., Hartley image rejection). In some embodiments, the mixer circuitry 922 of the receive signal path and the mixer circuitry 922 may be arranged for direct downconversion and direct upconversion, respectively. In some embodiments, the mixer circuitry 922 of the receive signal path and the mixer circuitry 922 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 920 may include analog-to-digital converter (ADC) and digital-to-analog converter (DAC) circuitry and the baseband circuitry 904 may include a digital baseband interface to communicate with the RF circuitry 920.

In some dual-mode embodiments, a separate radio IC circuitry may be provided for processing signals for each spectrum, although the scope of the embodiments is not limited in this respect.

In some embodiments, the synthesizer circuitry 928 may be a fractional −N synthesizer or a fractional N/N+1 synthesizer, although the scope of the embodiments is not limited in this respect as other types of frequency synthesizers may be suitable. For example, synthesizer circuitry 928 may be a delta-sigma synthesizer, a frequency multiplier, or a synthesizer including a phase-locked loop with a frequency divider.

The synthesizer circuitry 928 may be configured to synthesize an output frequency for use by the mixer circuitry 922 of the RF circuitry 920 based on a frequency input and a divider control input. In some embodiments, the synthesizer circuitry 928 may be a fractional N/N+1 synthesizer.

In some embodiments, frequency input may be provided by a voltage controlled oscillator (VCO), although that is not a requirement. Divider control input may be provided by either the baseband circuitry 904 or the application circuitry 902 (such as an applications processor) depending on the desired output frequency. In some embodiments, a divider control input (e.g., N) may be determined from a look-up table based on a channel indicated by the application circuitry 902.

Synthesizer circuitry 928 of the RF circuitry 920 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 928 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 920 may include an IQ/polar converter.

The FEM circuitry 930 may include a receive signal path which may include circuitry configured to operate on RF signals received from one or more antennas 932, amplify the received signals and provide the amplified versions of the received signals to the RF circuitry 920 for further processing. The FEM circuitry 930 may also include a transmit signal path which may include circuitry configured to amplify signals for transmission provided by the RF circuitry 920 for transmission by one or more of the one or more antennas 932. In various embodiments, the amplification through the transmit or receive signal paths may be done solely in the RF circuitry 920, solely in the FEM circuitry 930, or in both the RF circuitry 920 and the FEM circuitry 930.

In some embodiments, the FEM circuitry 930 may include a TX/RX switch to switch between transmit mode and receive mode operation. The FEM circuitry 930 may include a receive signal path and a transmit signal path. The receive signal path of the FEM circuitry 930 may include an LNA to amplify received RF signals and provide the amplified received RF signals as an output (e.g., to the RF circuitry 920). The transmit signal path of the FEM circuitry 930 may include a power amplifier (PA) to amplify input RF signals (e.g., provided by the RF circuitry 920), and one or more filters to generate RF signals for subsequent transmission (e.g., by one or more of the one or more antennas 932).

In some embodiments, the PMC 934 may manage power provided to the baseband circuitry 904. In particular, the PMC 934 may control power-source selection, voltage scaling, battery charging, or DC-to-DC conversion. The PMC 934 may often be included when the device 900 is capable of being powered by a battery, for example, when the device 900 is included in an UE. The PMC 934 may increase the power conversion efficiency while providing desirable implementation size and heat dissipation characteristics.

FIG. 9 shows the PMC 934 coupled only with the baseband circuitry 904. However, in other embodiments, the PMC 934 may be additionally or alternatively coupled with, and perform similar power management operations for, other components such as, but not limited to, the application circuitry 902, the RF circuitry 920, or the FEM circuitry 930.

In some embodiments, the PMC 934 may control, or otherwise be part of, various power saving mechanisms of the device 900. For example, if the device 900 is in an RRC Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used to execute Layer 3, Layer 2, or Layer 1 functionality, while processors of the application circuitry 902 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

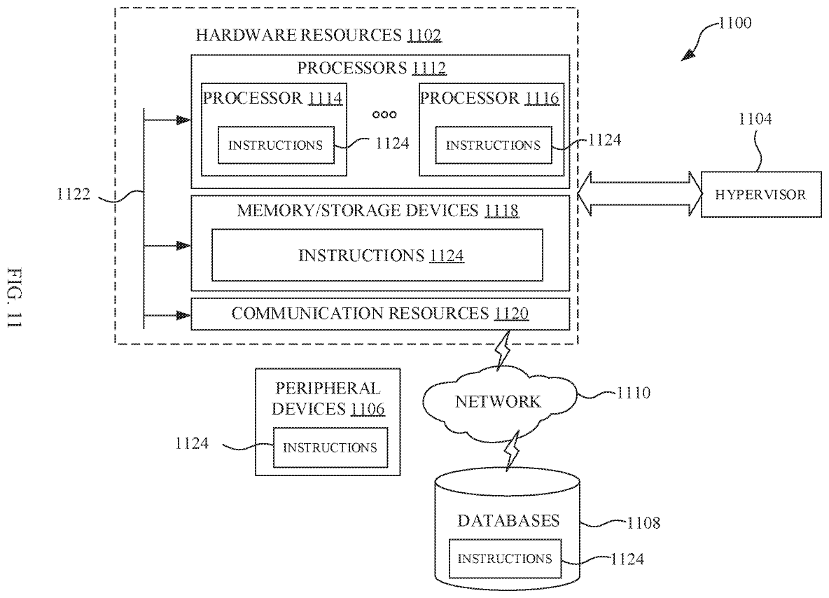

FIG. 10 illustrates example interfaces 1000 of baseband circuitry in accordance with some embodiments. As discussed above, the baseband circuitry 904 of FIG. 9 may include 3G baseband processor 906, 4G baseband processor 908, 5G baseband processor 910, other baseband processor(s) 912, CPU 914, and a memory 918 utilized by said processors. As illustrated, each of the processors may include a respective memory interface 1002 to send/receive data to/from the memory 918.

The baseband circuitry 904 may further include one or more interfaces to communicatively couple to other circuitries/devices, such as a memory interface 1004 (e.g., an interface to send/receive data to/from memory external to the baseband circuitry 904), an application circuitry interface 1006 (e.g., an interface to send/receive data to/from the application circuitry 902 of FIG. 9), an RF circuitry interface 1008 (e.g., an interface to send/receive data to/from RF circuitry 920 of FIG. 9), a wireless hardware connectivity interface 1010 (e.g., an interface to send/receive data to/from Near Field Communication (NFC) components, Bluetooth® components (e.g., Bluetooth® Low Energy), Wi-Fi@ components, and other communication components), and a power management interface 1012 (e.g., an interface to send/receive power or control signals to/from the PMC 934.

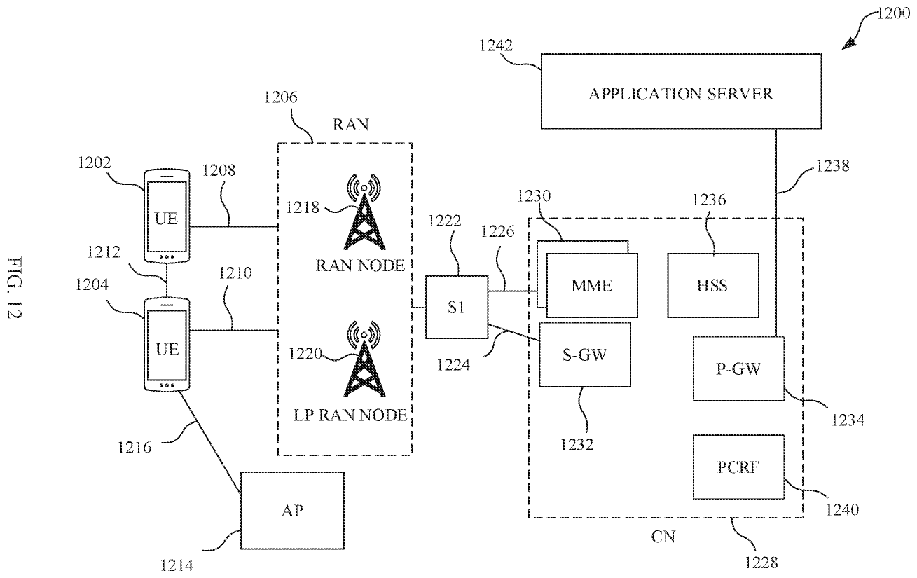

FIG. 11 is a block diagram illustrating components 1100, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1102 including one or more processors 1112 (or processor cores), one or more memory/storage devices 1118, and one or more communication resources 1120, each of which may be communicatively coupled via a bus 1122. For embodiments where node virtualization (e.g., NFV) is utilized, a hypervisor 1104 may be executed to provide an execution environment for one or more network slices/sub-slices to utilize the hardware resources 1102.

The processors 1112 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1114 and a processor 1116.

The memory/storage devices 1118 may include main memory, disk storage, or any suitable combination thereof. The memory/storage devices 1118 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1120 may include interconnection or network interface components or other suitable devices to communicate with one or more peripheral devices 1106 or one or more databases 1108 via a network 1110. For example, the communication resources 1120 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1124 may include software, a program, an application, an applet, an app, or other executable code for causing at least any of the processors 1112 to perform any one or more of the methodologies discussed herein. The instructions 1124 may reside, completely or partially, within at least one of the processors 1112 (e.g., within the processor's cache memory), the memory/storage devices 1118, or any suitable combination thereof. Furthermore, any portion of the instructions 1124 may be transferred to the hardware resources 1102 from any combination of the peripheral devices 1106 or the databases 1108. Accordingly, the memory of the processors 1112, the memory/storage devices 1118, the peripheral devices 1106, and the databases 1108 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

FIG. 12 illustrates an architecture of a system 1200 of a network in accordance with some embodiments. The system 1200 includes one or more user equipment (UE), shown in this example as a UE 1202 and a UE 1204. The UE 1202 and the UE 1204 are illustrated as smartphones (e.g., handheld touchscreen mobile computing devices connectable to one or more cellular networks), but may also include any mobile or non-mobile computing device, such as Personal Data Assistants (PDAs), pagers, laptop computers, desktop computers, wireless handsets, or any computing device including a wireless communications interface.

In some embodiments, any of the UE 1202 and the UE 1204 can include an Internet of Things (IoT) UE, which can include a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1202 and the UE 1204 may be configured to connect, e.g., communicatively couple, with a radio access network (RAN), shown as RAN 1206. The RAN 1206 may be, for example, an Evolved Universal Mobile Telecommunications System (E-UMTS) Terrestrial Radio Access Network (E-UTRAN), a NextGen RAN (NG RAN), or some other type of RAN. The UE 1202 and the UE 1204 utilize connection 1208 and connection 1210, respectively, each of which includes a physical communications interface or layer (discussed in further detail below); in this example, the connection 1208 and the connection 1210 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1202 and the UE 1204 may further directly exchange communication data via a ProSe interface 1212. The ProSe interface 1212 may alternatively be referred to as a sidelink interface including one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1204 is shown to be configured to access an access point (AP), shown as AP 1214, via connection 1216. The connection 1216 can include a local wireless connection, such as a connection consistent with any IEEE 802.11 protocol, wherein the AP 1214 would include a wireless fidelity (WiFi®) router. In this example, the AP 1214 may be connected to the Internet without connecting to the core network of the wireless system (described in further detail below).

The RAN 1206 can include one or more access nodes that enable the connection 1208 and the connection 1210. These access nodes (ANs) can be referred to as base stations (BSs), NodeBs, evolved NodeBs (eNBs), next Generation NodeBs (gNB), RAN nodes, and so forth, and can include ground stations (e.g., terrestrial access points) or satellite stations providing coverage within a geographic area (e.g., a cell). The RAN 1206 may include one or more RAN nodes for providing macrocells, e.g., macro RAN node 1218, and one or more RAN nodes for providing femtocells or picocells (e.g., cells having smaller coverage areas, smaller user capacity, or higher bandwidth compared to macrocells), e.g., a low power (LP) RAN node such as LP RAN node 1220.

Any of the macro RAN node 1218 and the LP RAN node 1220 can terminate the air interface protocol and can be the first point of contact for the UE 1202 and the UE 1204. In some embodiments, any of the macro RAN node 1218 and the LP RAN node 1220 can fulfill various logical functions for the RAN 1206 including, but not limited to, radio network controller (RNC) functions such as radio bearer management, uplink and downlink dynamic radio resource management and data packet scheduling, and mobility management.

In accordance with some embodiments, the UE 1202 and the UE 1204 can be configured to communicate using Orthogonal Frequency-Division Multiplexing (OFDM) communication signals with each other or with any of the macro RAN node 1218 and the LP RAN node 1220 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can include a plurality of orthogonal sub carriers.

In some embodiments, a downlink resource grid can be used for downlink transmissions from any of the macro RAN node 1218 and the LP RAN node 1220 to the UE 1202 and the UE 1204, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid includes a number of resource blocks, which describe the mapping of certain physical channels to resource elements. Each resource block includes a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1202 and the UE 1204. The physical downlink control channel (PDCCH) may carry information about the transport format and resource allocations related to the PDSCH channel, among other things. It may also inform the UE 1202 and the UE 1204 about the transport format, resource allocation, and H-ARQ (Hybrid Automatic Repeat Request) information related to the uplink shared channel. Typically, downlink scheduling (assigning control and shared channel resource blocks to the UE 1204 within a cell) may be performed at any of the macro RAN node 1218 and the LP RAN node 1220 based on channel quality information fed back from any of the UE 1202 and UE 1204. The downlink resource assignment information may be sent on the PDCCH used for (e.g., assigned to) each of the UE 1202 and the UE 1204.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1206 is communicatively coupled to a core network (CN), shown as CN 1228, via an S1 interface 1222. In embodiments, the CN 1228 may be an evolved packet core (EPC) network, a NextGen Packet Core (NPC) network, or some other type of CN. In this embodiment the S1 interface 1222 is split into two parts: the S1-U interface 1224, which carries traffic data between the macro RAN node 1218 and the LP RAN node 1220 and a serving gateway (S-GW), shown as S-GW 1232, and an S1-mobility management entity (MME) interface, shown as S1-MME interface 1226, which is a signaling interface between the macro RAN node 1218 and LP RAN node 1220 and the MME(s) 1230.

In this embodiment, the CN 1228 includes the MME(s) 1230, the S-GW 1232, a Packet Data Network (PDN) Gateway (P-GW) (shown as P-GW 1234), and a home subscriber server (HSS) (shown as HSS 1236). The MME(s) 1230 may be similar in function to the control plane of legacy Serving General Packet Radio Service (GPRS) Support Nodes (SGSN). The MME(s) 1230 may manage mobility aspects in access such as gateway selection and tracking area list management. The HSS 1236 may include a database for network users, including subscription-related information to support the network entities' handling of communication sessions. The CN 1228 may include one or several HSS 1236, depending on the number of mobile subscribers, on the capacity of the equipment, on the organization of the network, etc. For example, the HSS 1236 can provide support for routing/roaming, authentication, authorization, naming/addressing resolution, location dependencies, etc.

The S-GW 1232 may terminate the S1 interface 1222 towards the RAN 1206, and routes data packets between the RAN 1206 and the CN 1228. In addition, the S-GW 1232 may be a local mobility anchor point for inter-RAN node handovers and also may provide an anchor for inter-3GPP mobility. Other responsibilities may include lawful intercept, charging, and some policy enforcement.

The P-GW 1234 may terminate an SGi interface toward a PDN. The P-GW 1234 may route data packets between the CN 1228 (e.g., an EPC network) and external networks such as a network including the application server 1242 (alternatively referred to as application function (AF)) via an Internet Protocol (IP) interface (shown as IP communications interface 1238). Generally, an application server 1242 may be an element offering applications that use IP bearer resources with the core network (e.g., UMTS Packet Services (PS) domain, LTE PS data services, etc.). In this embodiment, the P-GW 1234 is shown to be communicatively coupled to an application server 1242 via an IP communications interface 1238. The application server 1242 can also be configured to support one or more communication services (e.g., Voice-over-Internet Protocol (VOIP) sessions, PTT sessions, group communication sessions, social networking services, etc.) for the UE 1202 and the UE 1204 via the CN 1228.

The P-GW 1234 may further be a node for policy enforcement and charging data collection. A Policy and Charging Enforcement Function (PCRF) (shown as PCRF 1240) is the policy and charging control element of the CN 1228. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1240 may be communicatively coupled to the application server 1242 via the P-GW 1234. The application server 1242 may signal the PCRF 1240 to indicate a new service flow and select the appropriate Quality of Service (QoS) and charging parameters. The PCRF 1240 may provision this rule into a Policy and Charging Enforcement Function (PCEF) (not shown) with the appropriate traffic flow template (TFT) and QoS class of identifier (QCI), which commences the QoS and charging as specified by the application server 1242.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method for a user equipment (UE), including: detecting a mobile indication provided by a mobile base station, wherein the mobile indication indicates a mobility property of the mobile base station; determining whether the UE is moving together with the mobile base station; and in response to determining that the UE is moving together with the mobile base station, applying a behavior based on the mobile indication.

Example 2 is the method of Example 1, wherein the mobile indication is included in a system information block type 1 (SIB1) of the mobile base station as one or more bits to indicate the moving property of the mobile base station including at least one of a moving type, a moving speed and a moving trajectory.

Example 3 is the method of Example 1 or 2, wherein the determining whether the UE is moving together with the mobile base station is based on a UE implementation, a condition provided together with the mobile indication, or a positioning of the UE.

Example 4 is the method of Example 3, wherein the condition provided together with the mobile indication comprises a speed threshold, a doppler spread threshold, a measurement sensitivity threshold, or a number of across-cell per unit time threshold.

Example 5 is the method of any of Examples 1 to 4, wherein the applying a behavior based on the mobile indication comprises: performing a cell reselection by regarding a cell or a frequency with the same mobile indication as a highest priority.

Example 6 is the method of any of Examples 1 to 4, wherein the applying a behavior based on the mobile indication comprises: performing a cell reselection by regarding a cell or a frequency with a different mobile indication or without the mobile indication as a lowest priority.

Example 7 is the method of any of Examples 1 to 4, wherein the applying a behavior based on the mobile indication comprises: performing a cell reselection by applying a configured scaling factor or offset to an idle measurement for a cell or frequency with the same mobile indication, wherein the configured scaling factor or offset is provided in a system information block type 1 (SIB1) of the mobile base station.

Example 8 is the method of any of Examples 1 to 4, wherein the applying a behavior based on the mobile indication comprises: performing a cell reselection by applying a configured scaling factor or offset to a cell reselection threshold for a cell or frequency with the same mobile indication, wherein the configured scaling factor or offset is provided in a system information block type 1 (SIB1) of the mobile base station.

Example 9 is the method of any of Examples 5, 7 and 8, wherein the cell with the same mobile indication is provided in a cell list for an intra-frequency cell reselection in a system information block type 3 (SIB3) of the mobile base station, and the frequency with the same mobile indication is provided in a frequency list for an inter-frequency cell reselection in a system information block type 4 (SIB4) of the mobile base station.

Example 10 is the method of any of Examples 1 to 9, further including: in response to determining that the UE is not moving together with the mobile base station, performing no access to a cell of the mobile base station, wherein a 1-bit indication is provided in a system information block type 1 (SIB1) of the mobile base station to indicate that the cell is only accessible for the UE moving together with the mobile base station.

Example 11 is the method of Example 10, wherein the UE that is not moving together with the mobile base station applies a reserved access identity (AI).

Example 12 is the method of any of Examples 1 to 10, wherein the applying a behavior based on the mobile indication comprises: performing a measurement for handover only for a cell or frequency with the same mobile indication.

Example 13 is the method of any of Examples 1 to 12, wherein the applying a behavior based on the mobile indication comprises: performing a measurement for handover based on a dedicated trigger event condition for a cell or frequency with a different mobile indication.

Example 14 is the method of Examples 13, wherein the dedicated trigger event condition comprises at least one of a measurement trigger threshold for events A1 to A6, a hysteresis for events A1 to A6 and a timer to trigger for events A1 to A6.

Example 15 is the method of any of Examples 1 to 14, wherein the applying a behavior based on the mobile indication comprises: performing a measurement for handover based on a dedicated measurement object or quantity, or a list of neighbor cells.

Example 16 is the method of any of Examples 1 to 15, wherein the applying a behavior based on the mobile indication comprises: performing a conditional handover (CHO) based on a CHO condition in which the mobile indication of a candidate target cell, a dedicated CHO condition and a dedicated time to trigger are provided.

Example 17 is the method of Example 16, wherein the candidate target cell with the same mobile indication is prioritized for CHO execution.

Example 18 is the method of any of Examples 1 to 17, wherein the mobile base station comprises an integrated access and backhaul (IAB) node.

Example 19 is an apparatus for a user equipment (UE), the apparatus including: one or more processors configured to perform steps of the method according to any of Examples 1-18.

Example 20 is a computer readable medium having computer programs stored thereon which, when executed by one or more processors, cause an apparatus to perform steps of the method according to any of Examples 1-18.

Example 21 is a method for a mobile base station, including: configuring a mobile indication for indicating a mobility property of the mobile base station; and providing the mobile indication to a user equipment (UE).

Example 22 is the method of Example 21, wherein the mobile indication is included in a system information block type 1 (SIB1) of the mobile base station as one or more bits to indicate the moving property of the mobile base station including at least one of a moving type, a moving speed and a moving trajectory,

Example 23 is the method of Example 21 or 22, wherein the mobile base station comprises an integrated access and backhaul (IAB) node.

Example 24 is a computer program product includes computer programs which, when executed by one or more processors, cause an apparatus to perform steps of the method according to any of Examples 1-18.

Example 25 is an apparatus for a communication device, including means for performing steps of the method according to any of Examples 1-18.

Example 26 is a computer program product includes computer programs which, when executed by one or more processors, cause an apparatus to perform steps of the method according to any of Examples 21-23.

Example 27 is an apparatus for a communication device, including means for performing steps of the method according to any of Examples 21-23.

Example 28 is an apparatus for a mobile base station, the apparatus including: one or more processors configured to perform steps of the method according to any of Examples 21-23.

Example 29 is a computer readable medium having computer programs stored thereon which, when executed by one or more processors, cause an apparatus to perform steps of the method according to any of Examples 21-23.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-20. (canceled)

21. A method comprising:
detecting an indication to indicate a cell is provided by a mobile integrated access and backhaul (IAB) node;
determining a user equipment (UE) is moving together with the IAB node; and
applying a behavior based on the indication and said determining the UE is moving together with the IAB node.

22. The method of claim 21, wherein the indication is included in a system information block type 1 (SIB1) and includes one bit to indicate the cell is provided by the mobile IAB node.

23. The method of claim 21, wherein determining the UE is moving together with the IAB node is based on a positioning of the UE.

24. The method of claim 21, wherein determining the UE is moving together with the IAB node is based on a condition provided together with the indication, wherein the condition comprises a speed threshold, a doppler spread threshold, a measurement sensitivity threshold, or a number of across-cell per unit time threshold.

25. The method of claim 21, wherein applying the behavior based on the indication comprises:
performing a cell reselection by regarding a frequency associated with the cell as a highest priority.

26. The method of claim 21, further comprising:
receiving, within a system information block type 4 (SIB4), a list of candidate cells associated with the mobile IAB node,
wherein applying the behavior includes selecting a candidate cell from the list of candidate cells for inter-frequency cell reselection.

27. The method of claim 21, wherein applying the behavior based on the indication comprises:
performing a cell reselection by regarding a frequency associated with a different cell as a lowest priority.

28. The method of claim 21, wherein applying the behavior based on the indication comprises:
performing a cell reselection by applying a configured scaling factor or offset to an idle measurement for a frequency associated with the cell, wherein the configured scaling factor or offset is provided in a system information block type 1 (SIB1).

29. The method of claim 21, wherein applying the behavior based on the indication comprises:
performing a cell reselection by applying a configured scaling factor or offset to a cell reselection threshold for a frequency associated with the cell, wherein the configured scaling factor or offset is provided in a system information block type 1 (SIB1).

30. The method of claim 21, wherein the cell is provided in a cell list for an intra-frequency cell reselection in a system information block type 3 (SIB3), and a frequency associated with the cell is provided in a frequency list for an inter-frequency cell reselection in a system information block type 4 (SIB4).

31. The method of claim 21, wherein applying the behavior comprises:
restricting handover measurements to cells or frequencies that provide the indication.

32. One or more non-transitory, computer-readable media having instructions that, when executed, cause processor circuitry to:
detect an indication to indicate a cell is provided by a mobile integrated access and backhaul (IAB) node;
determine a user equipment (UE) is moving together with the IAB node; and
apply a behavior based on the indication and said determination that the UE is moving together with the IAB node.

33. The one or more non-transitory, computer-readable media of claim 32, wherein the indication is included in a system information block type 1 (SIB1) and includes one bit to indicate the cell is provided by the mobile IAB node.

34. The one or more non-transitory, computer-readable media of claim 32, wherein to apply the behavior based on the indication the processor circuitry is to:
perform a cell reselection by regarding a frequency associated with the cell as a highest priority.

35. The one or more non-transitory, computer-readable media of claim 32, wherein the instructions, when executed, further cause the processor circuitry to:
receive, within a system information block type 4 (SIB4), a list of candidate cells associated with the mobile IAB node,
wherein to apply the behavior the processor circuitry is to select a candidate cell from the list of candidate cells for inter-frequency cell reselection.

36. The one or more non-transitory, computer-readable media of claim 32, wherein the cell is a first cell and to apply the behavior the processor circuitry is to:
perform a measurement for handover based on a dedicated trigger event condition for a second cell or frequency with a different indication.

37. A method comprising:
generating an indication to indicate a cell is provided by a mobile integrated access and backhaul (IAB) node; and
generating a message for transmitting the indication.

38. The method of claim 37, wherein the message is a system information block type 1 (SIB1).

39. The method of claim 37, wherein the indication is one bit to indicate the cell is provided by the mobile IAB node.

40. The method of claim 37, further comprising:
generating, for transmission, a system information block type 4 (SIB4) with a list of candidate cells associated with the mobile IAB node.
